(19) United States
(12) Patent Application Publication
(10) Pub. No.: US 2022/0373693 A1
(43) Pub. Date: Nov. 24, 2022

(54) Remote Controlled System for Precision Tracking of Irrigation Equipment with GPS and Ultra-Wideband Communication Protocol

(71) Applicant: James Hobbs, Hobe Sound, FL (US)

(72) Inventor: James Hobbs, Hobe Sound, FL (US)

(21) Appl. No.: 17/328,571

(22) Filed: May 24, 2021

(51) Int. Cl. G01S 19/14; H04H 60/53

(52) U.S. Cl. CPC G01S 19/14; H04H 60/53; A01G 25/16

(57) ABSTRACT

A remote controlled system for precision tracking of irrigation equipment with GPS and ultra-wideband communication protocol is designed to track irrigation equipment, including a solenoid valve, through use of a global positioning system (GPS), and an Ultra-Wideband (UWB) communication protocol with a remote control device. The system provides a remote control device to track the location of the solenoid valve, or other irrigation equipment. The GPS tracks the approximate location of the solenoid valve, and the UWB communication protocol provides a more precise tracking capability, locating the exact location of solenoid valves, both underground, and above ground. The remote control device and an agricultural clock, are both in signal communication with the GPS and Ultra-Wideband communication protocols. Further, the agricultural clock utilizes a mesh network, i.e., Z-wave to transmit commands that control the timing and amount of water discharged through the solenoid valve across multiple agricultural zones.

### CROSS-REFERENCES TO RELATED APPLICATIONS

This CIP application claims priority from U.S. Continuation in Part application Ser. No. 17/227,409, entitled “IRRIGATION SOLENOID VALVE SWITCH ASSEMBLY OPERABLE ON A MESH NETWORK”, filed on Apr. 12, 2021, which application is hereby incorporated herein by reference in its entirety.

### FIELD OF THE INVENTION

The present invention relates generally to a remote controlled system for precision tracking of irrigation equipment with GPS and ultra-wideband communication protocol. More so, the present invention relates to a remote controlled system for tracking irrigation equipment through GPS, and Ultra-Wideband communication protocol operable with a remote control device; and further includes a valve switch assembly that operates across a mesh network to transmit commands that control the timing and amount of water discharged through a solenoid valve in multiple agricultural zones.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often, In the field of crop irrigation, there is a natural need for automated software tools and applications that may assist an owner in site operation, proper irrigation of a site for proper delivery of nutrients or pesticides to plants, and accurate crop data collection. For example, it may be desirable to have access to an automated interactive system which could be used to optimize or update an irrigation schedule in real time based on data collected from a crop, metrological conditions, soil conditions, and type of crops being irrigated.

Irrigation systems supply water to soil. They are primarily used to assist in the growing of agricultural crops and maintenance of landscapes. Irrigation systems typically include valves, controllers, pipes, and emitters such as sprinklers or drip tapes. Irrigation systems are usually divided into zones based on the spatial resolution of the detection system, and irrigation is performed on that zone based on reflection from all the crop plants within that zone. Each zone may have a solenoid valve controlled via irrigation controller opening or closing irrigation zones. The irrigation controller may be a mechanical or electrical device signaling a zone to turn start irrigating a section of crop for a specific amount of time, or until it is turned off manually.

In many instances, command systems for commercial building and residential automation functions are available using a range of technologies. Among numerous technologies currently in use are X10®, Z-Wave® and Zigbee® technologies. Z-Wave technology is supported by a consortium of users and product developers, who have promulgated a set of Z-Wave communication standards that available through Zensys and the Z-Wave Alliance.

It is known in the art that Z-Wave is based on a mesh network topology. This means each (non-battery) device installed in the network becomes a signal repeater. Z-Wave is a wireless home automation protocol that operates in the 908.42 MHz frequency band. One of the features of Z-Wave is that it utilizes a type of network known as a “mesh network,” which means that one Z-Wave device will pass a data frame along to another Z-Wave device in the network until the data frame reaches a destination device. As a result, Z-Wave signals easily travel through most walls, floors and ceilings, the devices can also intelligently route themselves around obstacles to attain seamless, robust coverage.

Generally, Z-Wave has a range of 100 meters or 328 feet in open air, building materials reduce that range, it is recommended to have a Z-Wave device roughly every 30 feet, or closer for maximum efficiency. The Z-Wave signal can hop roughly 600 feet, and Z-Wave networks can be linked together for even larger deployments. Each Z-Wave network can support up to 232 Z-Wave devices provides the flexibility to add as many devices to the network.

Often, the Z-Wave network comprises a primary hub controller and at least one controllable device, known as a slave node, or more simply, a “node.” The controller establishes the Z-Wave network. The controller is the only device in a Z-Wave network that determines which Z-Wave nodes belong to the network. The primary hub controller is used to add or remove nodes from the network. The process of adding or removing nodes, also known as inclusion/exclusion, requires that the controller must be within direct radio frequency (RF) range of the node that is to be added or deleted from the network.

The user must interact with the controller and the device during this process. For example, to start the process, the controller and the device should be brought together in close physical proximity. Next, the controller is placed in an inclusion mode. Then the device is activated so that it will enroll in the Z-Wave network. After nodes are added to the network, the primary controller is responsible for determining communication routes to nodes, based on feedback from every node that the controller adds to the network. Additional nodes can be added at any time.

Other proposals have involved systems for controlling solenoid valves. The problem with these paging systems is that they do not utilize a flexible wireless communication system, such as Z-wave. Also, the hub controller cannot be controlled for powering on and restricting specific zones in the field. Even though the above cited systems for irrigating fields meet some of the needs of the market, a valve switch assembly that uses a mesh network to transmit commands that control the timing and amount of water discharged through a solenoid valve in multiple agricultural zones, is still desired.

### SUMMARY

Illustrative embodiments of the disclosure are generally directed to an irrigation solenoid valve switch assembly that is operable on a mesh network. The irrigation solenoid valve switch assembly uses a mesh network to transmit valve commands that control the timing and amount of water discharged through a solenoid valve in multiple agricultural zones.

In one embodiment, the irrigation solenoid valve switch assembly comprises a solenoid valve that is operable to regulate the flow of water. The irrigation solenoid valve switch assembly also comprises a clock that is operable to generate one or more valve command signals. The valve command signals are configured to control the timing and amount of water discharged through the solenoid valve.

In some embodiments, the irrigation solenoid valve switch assembly also comprises a hub controller that is operatively connected to the clock. The hub controller is configured to transmit the valve command signals over a mesh network. The irrigation solenoid valve switch assembly also comprises a switch that operatively connects to the solenoid valve. The switch is configured to receive the valve command signals. The switch is operable to control the solenoid valve in correspondence to the valve command signals. The switch has a rechargeable battery that feeds direct current (D/C) to the switch for operation of the solenoid valve.

In another aspect, the assembly further comprises multiple signal repeaters operable to carry the valve command signals across the mesh network.

In another aspect, the switch comprises a rechargeable battery.

In another aspect, the switch operates with direct current from the rechargeable battery.

In another aspect, the switch comprises a pair of wires configured to couple to corresponding wires for the solenoid valve.

In another aspect, the hub controller, or the switch, or both comprise an Internet Wi-Fi transceiver.

In another aspect, the solenoid valve comprises a water valve and a solenoid.

In another aspect, the water valve comprises an electrically controlled water valve.

In another aspect, the water valve is configured to open for discharging water, and close for restricting the discharge of water.

In another aspect, the assembly comprises multiple switches operable with multiple solenoid valves across multiple agricultural zones.

In another aspect, the signal repeaters are operatively disposed across the agricultural zones.

In another aspect, the hub controller comprises multiple channels corresponding to the agricultural zones.

In another aspect, the switch comprises a waterproof housing.

In another aspect, the switch has dimensions up to 6 inches in length, 3 inches in width, and 2 inches in thickness.

In another aspect, the mesh network includes at least one following networks: a Z-wave network, a Zigbee network, a packet radio network, a thread network, an Smash network, a SolarMESH project network, and a WiBACK wireless technology network.

One objective of the present invention is to create a more efficient irrigation system by regulating water discharge across multiple agricultural zones over a mesh network.

Another objective is to provide a switch that is universally operable with multiple types of solenoid valves.

Another objective is to minimize the charging requirements of the switch through use of a long-lasting battery.

Yet another objective is to use DC current, so as to negate the need for constant electrical power, as needed with an A/C power source.

Additional objectives are to provide a mesh network that operates the simple switch.

An exemplary objective is to position the signal repeaters strategically around multiple agricultural zones, so as to optimize the mesh network.

Additional objectives are to provide a strong signal, even with walls, fences, and barriers segregating the agricultural zones.

Yet another objective is to make the assembly portable over different types of agricultural and non-agricultural environments.

Yet another objective is to provide an inexpensive to manufacture irrigation solenoid valve switch assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary irrigation solenoid valve switch assembly operable on a mesh network across multiple agricultural zones, in accordance with an embodiment of the present invention;

FIG. 1 illustrates a perspective view of an exemplary irrigation solenoid valve switch assembly operable on a mesh network across multiple agricultural zones, in accordance with an embodiment of the present invention;

FIG. 2 illustrates a block diagram of an exemplary Z-wave network, in accordance with an embodiment of the present invention;

FIG. 3 illustrates a perspective view of an exemplary switch, in accordance with an embodiment of the present invention;

FIG. 4 illustrates a rear view of the switch shown in FIG. 3, showing a sectioned view of a battery and a transreceiver, in accordance with an embodiment of the present invention;

FIG. 5 illustrates a perspective view of the switch wired to a solenoid valve, in accordance with an embodiment of the present invention;

FIG. 6 illustrates a perspective view of an exemplary clock connected to a hub controller, in accordance with an embodiment of the present invention;

FIG. 7 illustrates a block diagram depicting an exemplary client/server system which may be used by an exemplary web-enabled/networked embodiment, in accordance with an embodiment of the present invention;

FIG. 8 illustrates a diagram of an exemplary global positioning system (GPS) operable with the assembly to help track the location of a solenoid valve, in accordance with an embodiment of the present invention;

FIG. 9 illustrates a perspective view of an exemplary a GPS controller positioned at or on the end of field for controlling selected location and tracking functions of the assembly, in accordance with an embodiment of the present invention;

FIG. 10 illustrates a diagram of an exemplary irrigation solenoid valve switch assembly operable on a mesh network across multiple agricultural zones, and an exemplary global positioning system (GPS) operable with the assembly to help track the location of a solenoid valve, in accordance with an embodiment of the present invention;

FIG. 11 illustrates a perspective view of an exemplary faulty solenoid valve buried under the ground being tracked, in accordance with an embodiment of the present invention;

FIG. 12 illustrates a block diagram of a remote control device tracking an underground solenoid with GPS and Ultra-Wideband communications, in accordance with an embodiment of the present invention;

FIG. 13 illustrates a block diagram of a Time-Distance of Arrival between anchors and a sensor, in accordance with an embodiment of the present invention

FIG. 14 illustrates a graph showing tracking measurements of a prototype UWB passive tracking system as compared to tracking measurements utilizing a GPS system, in accordance with an embodiment of the present invention;

FIG. 15 illustrates a schematic diagram of a UWB geo-positional model where multiple remote controllers or mobile devices collaborate with a requesting tag to allow the requesting tag to determine its location and elevation, in accordance with an embodiment of the present invention; and

FIG. 16 illustrates a schematic diagram of exemplary hardware environment for operation of the ultra-wideband system, in accordance with an embodiment of the present invention.

Like reference numerals refer to like parts throughout the various views of the drawings.

### DETAILED DESCRIPTION OF THE INVENTION

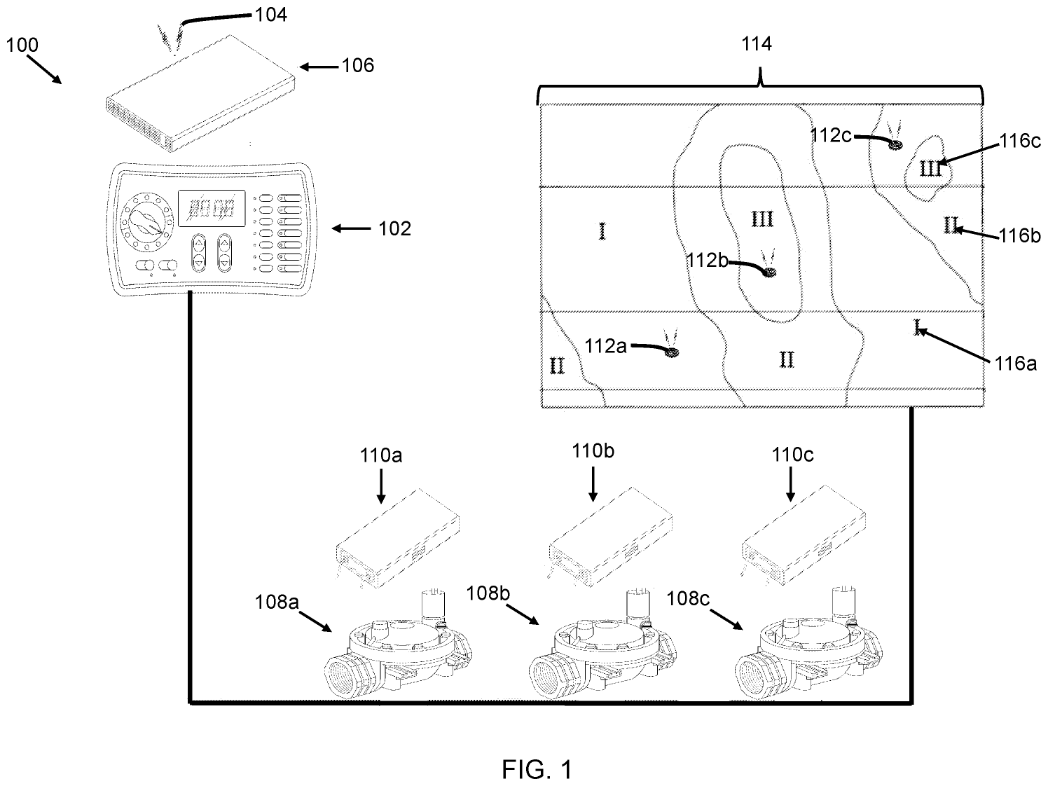

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An irrigation solenoid valve switch assembly 100 operable on a mesh network is referenced in FIG. 1. The irrigation solenoid valve switch assembly 100, hereafter “assembly 100”, uses a mesh network 200 to transmit valve command signals 102 that control the timing and amount of water discharged through multiple solenoid valves 108a, 108b, 108c across multiple zones 116a-c in a field 114. In one non-limiting embodiment, the zone comprises an agricultural zone requiring irrigation. The field 114 may be divided into agricultural zones based on the spatial resolution of the detection system, whereby irrigation is performed on that zone based on reflection from all the crop plants within that zone. However, the zones may also encompass non-agricultural irrigation-related areas, including, without limitation, golf courses, sports fields, gardens, green houses, buildings, malls, and the like.

The solenoid valves 108a-c regulate the flow of water through the different zones 116a-c in the field 114. Any combination of solenoid valves can be used with one, or multiple zones in the field. For example, one solenoid valve can be used in one zone; or one solenoid valve can regulate water discharge in multiple zones; or multiple solenoid valves can regulate water discharge in one zone. For example, FIG. 1 illustrates three different zones 116a, 116b, 116c that receive water from one or more solenoid valves 108a-c. The solenoid valves 108a-c may include a solenoid and a water valve, as is known in the art of irrigation.

The assembly 100 is unique in utilizing a clock 102, or agricultural controller, that generates valve command signals 104 that control the timing and amount of water discharged through the solenoid valves 108a-c. Continuing with assembly 100, a hub controller 106 operatively connects to the clock 102. The hub controller 106 transmits the valve command signals 104 over the mesh network 200.

Multiple signal repeaters 112a-c are operatively disposed across the field to relay the valve command signals 104. Another unique feature is the use of multiple switches 110a-c, with each switch 110a, 110b, 110c correlating, or operatively connected to a solenoid valve. The switches 110a-c receive the valve command signals 104 from the hub controller 106, and convert the valve command signal into another signal or mechanical action to control a corresponding solenoid valve.

In this manner, the valve command signal 104 can control one or more of the solenoid valves in the different agricultural zones. Significantly, the switches 110a-c include a rechargeable battery 400 that feeds direct current (D/C) to the switch for operation of the solenoid valve. And as is inherent with a mesh network, multiple relay signal repeaters 112a, 112b, 112c carry the valve command signals 104 across the mesh network 200. In this manner, the assembly 100 enables selective discharge or restriction of water for each agricultural zone in a field.

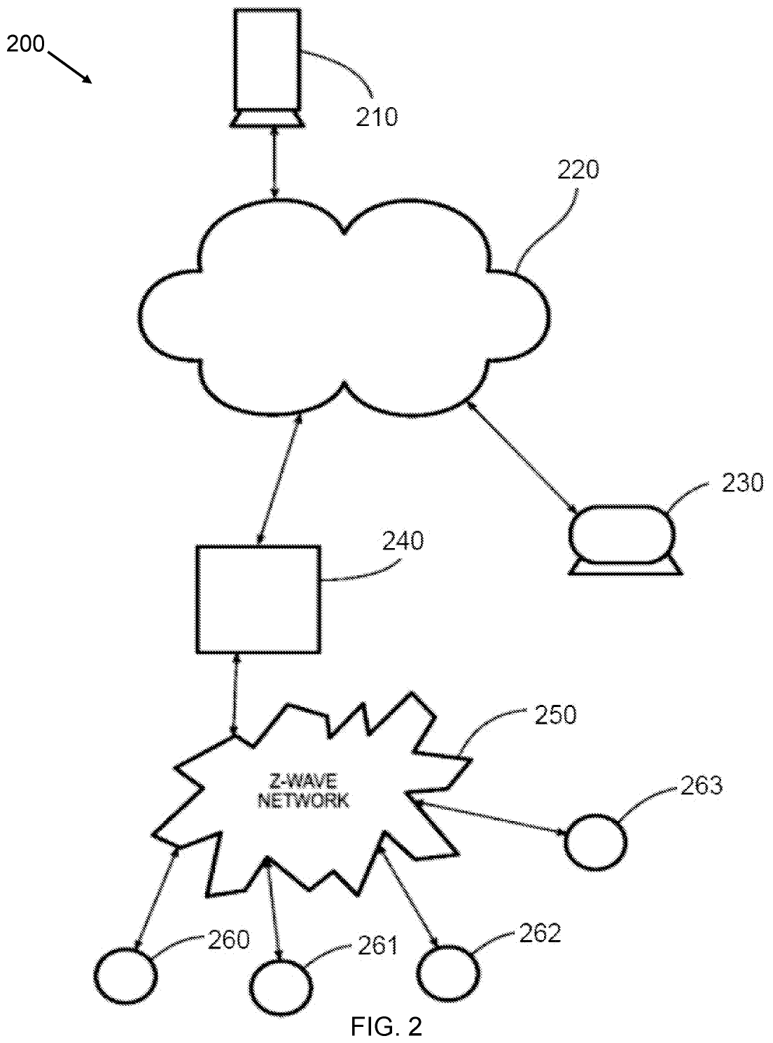

Looking now at FIG. 2, a primary operational function of the assembly 100 is the operation of irrigation valves over long distances in an agricultural environment, and over multiple agricultural zones, through use of a mesh network 200. The assembly 100 uses the mesh network 200 to transmit valve commands that control the timing and amount of water discharged through a solenoid valve 108a-c in multiple agricultural zones. The mesh network 200 may include, without limitation, a Z-wave network, a Zigbee network, a packet radio network, a thread network, a Smash network, a SolarMESH project network, and a WiBACK wireless technology network. By utilizing a mesh network 200, greater distances may be covered across fields, or other environments in which assembly may be operable.

In one non-limiting embodiment, the mesh network 200 is a Z-wave wireless communication protocol that comprises of low-energy radio waves to communicate between signal repeaters 112a, 112b, 112c, i.e., relay points, across the zones 116a-c. The Z-wave network can be controlled via the Internet with intercommunication between multiple relay points positioned throughout the agricultural zones.

As shown in schematic diagram of a mesh network 200, a Z-wave wireless communication protocol forms a Z-wave network 250. The Z-wave network 250 enables communications in the zones. It is known in the art that the Z-wave network 250 comprises a mesh network defined by low-energy radio waves. In some embodiments, the Z-wave network 250 includes a hub controller 104. The Z-wave network 250 comprises of a mesh network of low-energy radio waves to communicate between signal repeaters 112a-c, i.e., relay points, across the zones 116a-c.

The Z-wave network 250 can be controlled via the Internet with intercommunication between multiple relay points positioned throughout the zones. In some embodiments, the Z-wave network 250 may also include an Internet Wi-Fi transceiver. The Z-wave network 250 may also include multiple signal repeaters 112a-c that are operatively disposed across the zones. In other embodiments, the signal repeaters 112a-c are operatively disposed between tables and across walls in the zones.

Those skilled in the art will recognize that the numerous fences, trees, and hills in a field 114 require a mesh network to optimize communications between switches and solenoid valves in which infrastructure nodes, i.e., bridges, switches, and other infrastructure devices, connect directly, dynamically, and non-hierarchically. One exemplary mesh network is shown in a schematic diagram of the mesh network 200 (FIG. 2). The mesh network 200 includes Internet 220 and Z-wave network 250. As illustrated, a number of devices are in communication with each other over Internet 220, including a portal server 210, a user device 230 and a Z-wave networking device 240. User device 230 may communicate with portal server 210 through a web browser interface, using standard hypertext transfer protocol (HTTP).

In one embodiment of the mesh network 200, a portal server 210 communicates with Z-wave networking device 140 through lower layer Internet protocols, such as Transmission Control Protocol/Internet Protocol (TCP/IP) or User Datagram Protocol/Internet Protocol (UDP/IP). Z-wave networking device 240 conducts radio frequency (RF) communications with Z-wave networking devices 260-263. It should be noted that some devices 260-263 may be in direct communication with Z-wave networking device 240. As Z-wave network 250 is a mesh network, some devices 260-263 may communicate with Z-wave networking device 240 indirectly, through other devices 260-263.

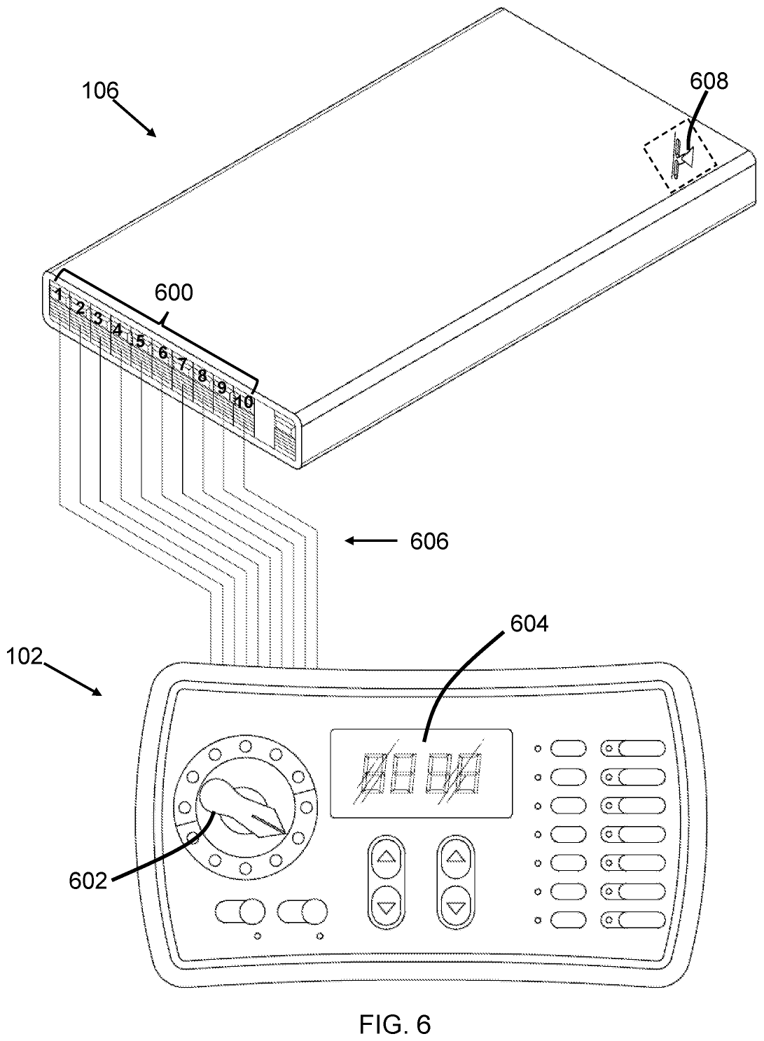

Looking ahead to FIG. 6, the assembly 100 comprises a clock 102 that is operable to generate one or more valve command signals 104. The valve command signals 104 are configured to control the timing and amount of water discharged through the solenoid valve. The clock 102 can have a control switch 602 and a display 604 to enable manual control of the timing and amount of water discharged from solenoid valves 108a-c. For example, FIG. 1 illustrates a perspective view of an exemplary irrigation solenoid valve switch assembly operable on a mesh network across multiple agricultural zones.

In some embodiments, the assembly 100 also comprises a hub controller 106 that is operatively connected to the clock 102. This connection may be through an NFC cord 606, or possibly through wireless means. The hub controller 106 is configured to transmit the valve command signals 104 over a mesh network. In some embodiments, the hub controller 106 comprises an Internet Wi-Fi transceiver to transmit the valve command signals 104.

In other embodiments, the hub controller 106 also comprises a processor, which may be operable with an algorithm. The algorithm in the processor is configured to calculate the timing of water discharge, and predetermined needs for specific plants. The processor is also configured to calculate the proximate position of the solenoid valves relative to each other, so as to optimize discharge of water onto the fields, and across the agricultural zones. In some embodiments, an algorithm, which is operable in hub controller 106, acts to regulate communications between the clock and the solenoid valve.

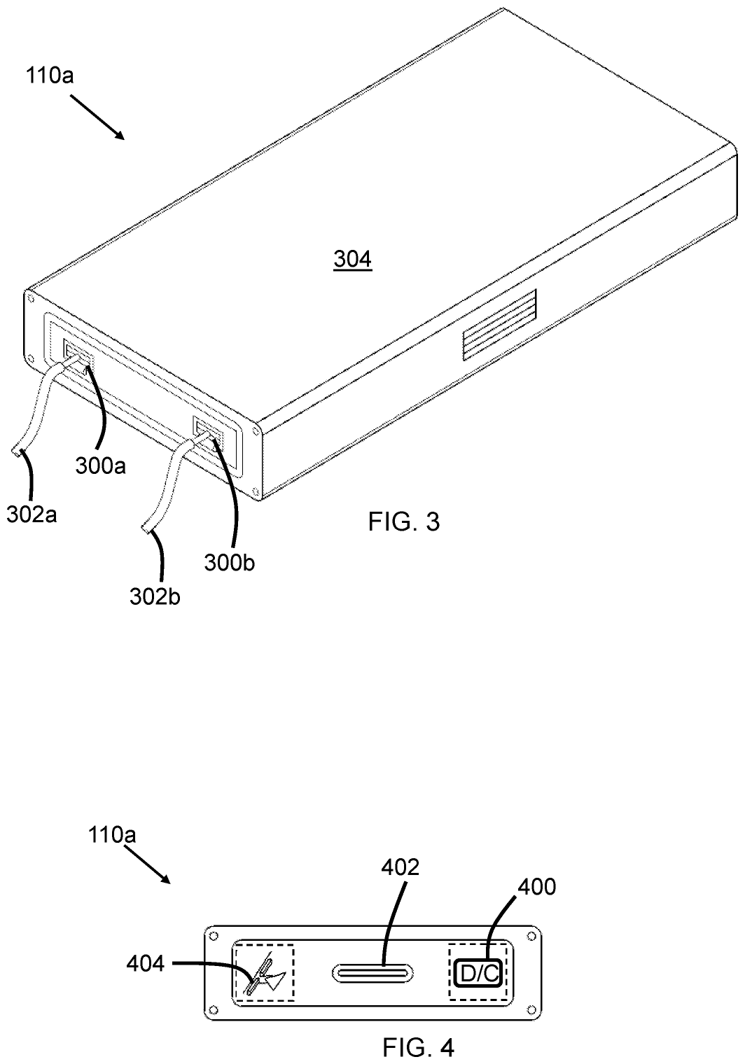

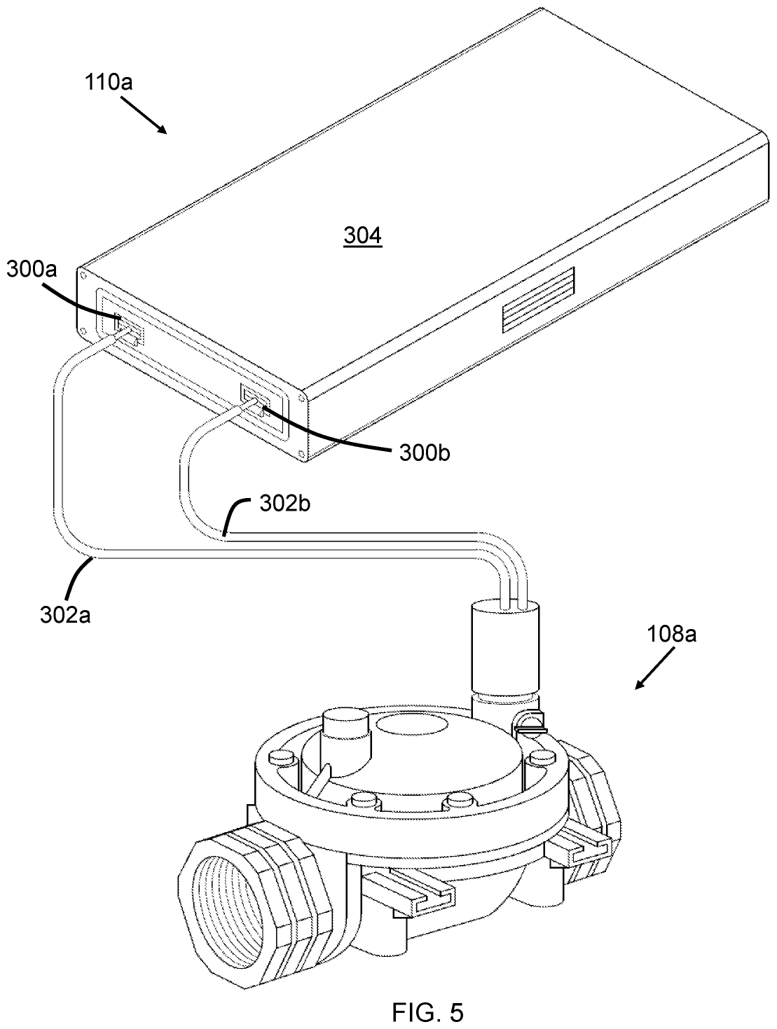

Looking at FIG. 3, the assembly 100 comprises a switch 110a that operatively connects to the solenoid valve 108a. The switch 110a is configured to receive the valve command signals 104. The switch 110a is operable to control the solenoid valve in correspondence to the valve command signals 104. Thus, in one possible embodiment, the switch 110a may have two wires 302a-b that couple to two correlating wires from the solenoid valve 108a to enable operational communication, and allow the solenoid valve 108a to register commands from the switch 110a. In some embodiments, the switch 110a comprises an Internet Wi-Fi transceiver 404 for receiving the valve command signals 104 from the control hub. This is, however, transmitted over the mesh network.

In some embodiments, the switch 110a comprises a waterproof housing 304. This can be useful in an agricultural environment where rain, pests, and irrigation flow can disperse moisture and contaminants into the switch 110a electrical components. In one non-limiting embodiment, the housing 304 has dimensions up to 6″ in length, 3″ in width, and 2″ in thickness—approximately the size of a smart phone. However, the assembly 100 is scalable, such that any dimensions, smaller or larger may also be used. The simplicity of the switch 110a allows it to be universally adapted to numerous types of solenoid valves.

Looking now at FIG. 4, the switch 110a comprises a rechargeable battery 400 that feeds direct current (D/C) to the switch 110a for operation of the solenoid valve. A charging port 402 in the back side of switch 110a enables a cord to charge the battery 400 accordingly. However, in alternative embodiments, alternating current (A/C) may be used. The use of D/C power is advantageous in that the need for constant electrical power, as needed with an A/C power source, is negated. The D/C power source from the rechargeable battery flows electric charge in one direction, towards the solenoid valve in a steady state of a constant-voltage circuit. This is preferable in the agricultural fields over the A/C, which is a time-varying voltage source, periodically reversing direction. In another embodiment, the switch 110a comprises a pair of wires 302a, 302b that are configured to couple to corresponding wires for the solenoid valve. Th wires 302a-b can operatively connect to a correlating pair of wire ports 300a, 300b in the switch 110a. The wires 302a-b may include a black and red wire, signifying ground and hot, for example.

In one possible, the solenoid valve comprises a water valve and a solenoid. The water valve is configured to open for discharging water, and close for restricting the discharge of water. The water valve may be an electrically controlled water valve. The solenoid can include a coil of wire used as an electromagnet that creates a magnetic field from the direct current from the battery. The generated magnetic field creates linear motion to move the water valve between the open and closed positions.

In one embodiment, shown in FIG. 1, the assembly 100 utilized multiple switches 110a-c operable with multiple solenoid valves 108a-c across the multiple zones 116a-c of the field 114. For example, ten solenoid valves operated by ten connected switches could be used for each agricultural zone. The first agricultural zone may grow rice, and thus require the most water. The second agricultural zone may grow alfalfa, and thus require lesser quantities of water for the alfalfa crop. The clock 102 deciphers, or is programmed to know, which crops require what quantity of water, and when the valves should be opened. In another example, a Z-Wave network can support up to 232 switches and correlating solenoid valves, which provides the flexibility to add as many switches to the network as the field can retain.

In some embodiments, the hub controller 106 transmits the generated valve command signals 104 from the clock 102. In one embodiment, multiple signal repeaters 112a-c are operatively disposed across the zones 116a-c, so as to transmit the appropriate signal 104 to the correlating solenoid valve. In yet another embodiment, shown in FIG. 6, the hub controller 106 comprises multiple channels 600 corresponding to the agricultural zones 116a, 116b, 116c. As illustrated, ten channels are shown.

In one possible embodiment, the channels 600 can be integrated or disconnected to selectively enable the solenoid valve to discharge or restrict water for the corresponding agricultural zone. For example, a channel #3 can be turned off to restrict communications between the hub controller 106 and the switch 110c for the solenoid valve in zone #3. Or, channels 1-4 can be turned on to initiate communications between the hub controller and switches and solenoid valves in agricultural zones 1-4. The channel can be manually switched on or off to enable or disable communications. This may include opening and closing a circuit for a transreceiver 608 in the hub controller 106; whereby the circuit regulates the transreceiver 608.

The switch 110a has a controller, or clock 102, that transmits commands across a mesh network. The switch 110a is a small, thin device, about the size of a smart phone that is configured to couple to a pair of outlet wires extending out from a solenoid that operates a valve. The switch 110a has a waterproof housing, a transreceiver, and a battery. The transreceiver receives the command signals 104 from the controller for operation of the valve, through the solenoid.

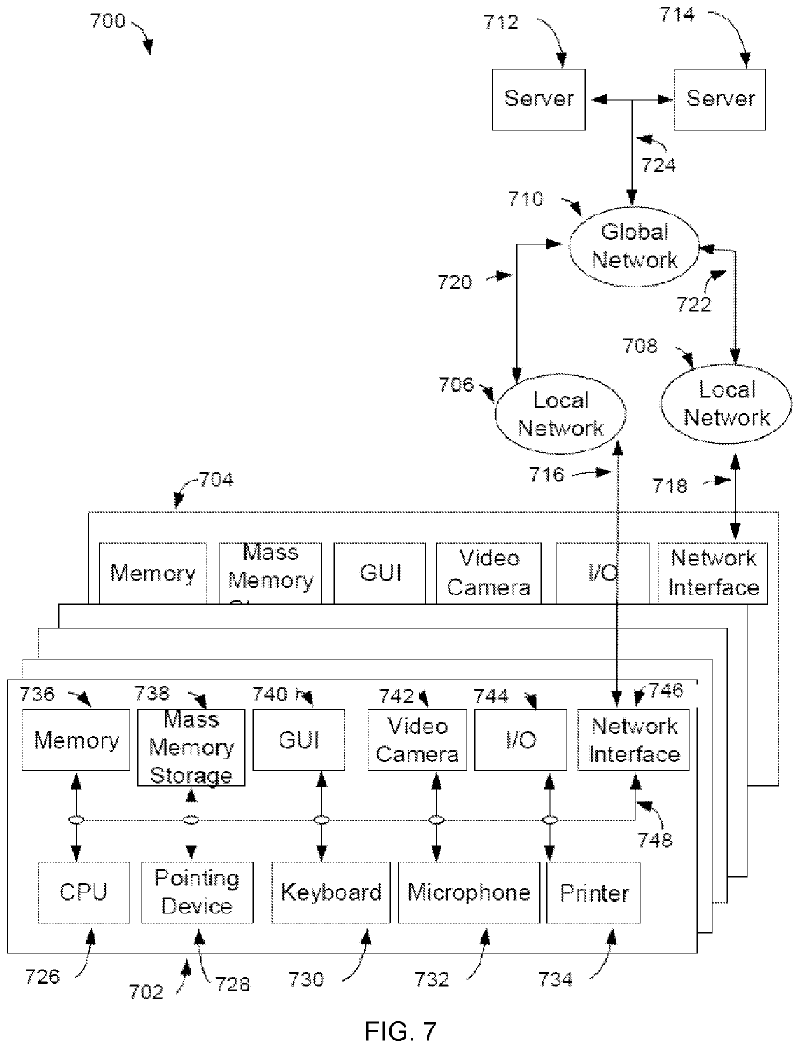

FIG. 7 is a block diagram depicting an exemplary client/server system which may be used by an exemplary web-enabled/networked embodiment of the present invention. A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones. Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

In conclusion, irrigation solenoid valve switch assembly 100 is operable on a mesh network. The assembly uses a mesh network to transmit valve command signals that control the timing and amount of water discharged through a solenoid valve in multiple agricultural zones. A solenoid valve regulates the flow of water. A clock, or agricultural controller, generates valve command signals that control the timing and amount of water discharged through the solenoid valve. A hub controller operatively connects to the clock. The hub controller transmits the valve command signals over the mesh network. A switch operatively connects to the solenoid valve. The switch receives the valve command signals to control the solenoid valve, in correspondence to the valve command signals. The switch has a rechargeable battery that feeds direct current to the switch for operation of the solenoid valve. Multiple relay signal repeaters carry the valve command signals across the mesh network.

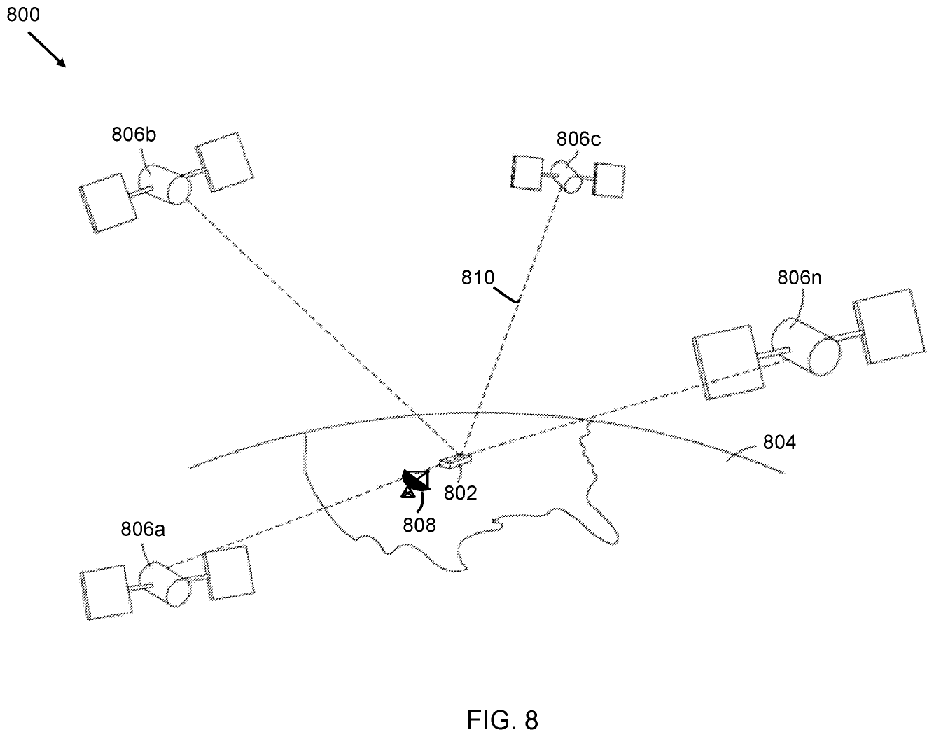

Turning now to FIG. 8, a global positioning system (GPS) 800 is operable with the assembly 100 to help track the location of the solenoid valve 108a when an event, such as a faulty solenoid valve, or required maintenance, occurs. Those skilled in the art will recognize that GPS is a system of at least thirty navigation satellites 806a, 806b, 806c, 806n circling the Earth 804. Working in conjunction with the signals transmitted by the navigation satellites 806a-n is a GPS module, or GPS receiver, as is known in the art. In the present invention, at least one GPS module 808 is integral and operatively connected to the solenoid valve and/or the hub controller to help identify the location of each in the field.

Thus, as is known in the art, when a solenoid valve 802, which is buried beneath the ground, has mechanical problems or maintenance requirements, the GPS system 800 works to indicate the location of the solenoid valve 802. The GPS module 808 is then operable to receive satellite signals from the GPS satellites 806a-n to determine a current location of the solenoid valve 802 as a function of the received satellite signals 810. Once the GPS module 808 calculates its distance from four or more GPS satellites 806a-n, the location of the solenoid valve can be determined. A technician may then dig under the ground at an accurate location to retrieve and remedy the faulty solenoid valve.

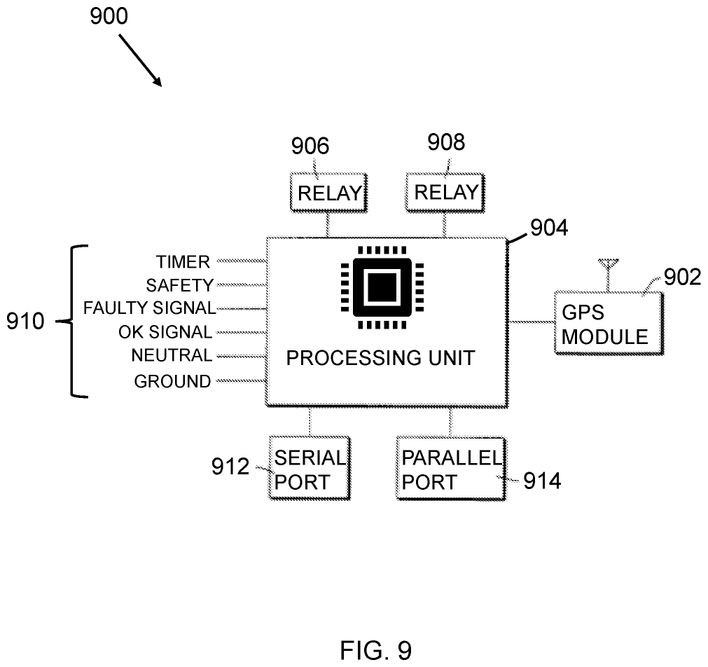

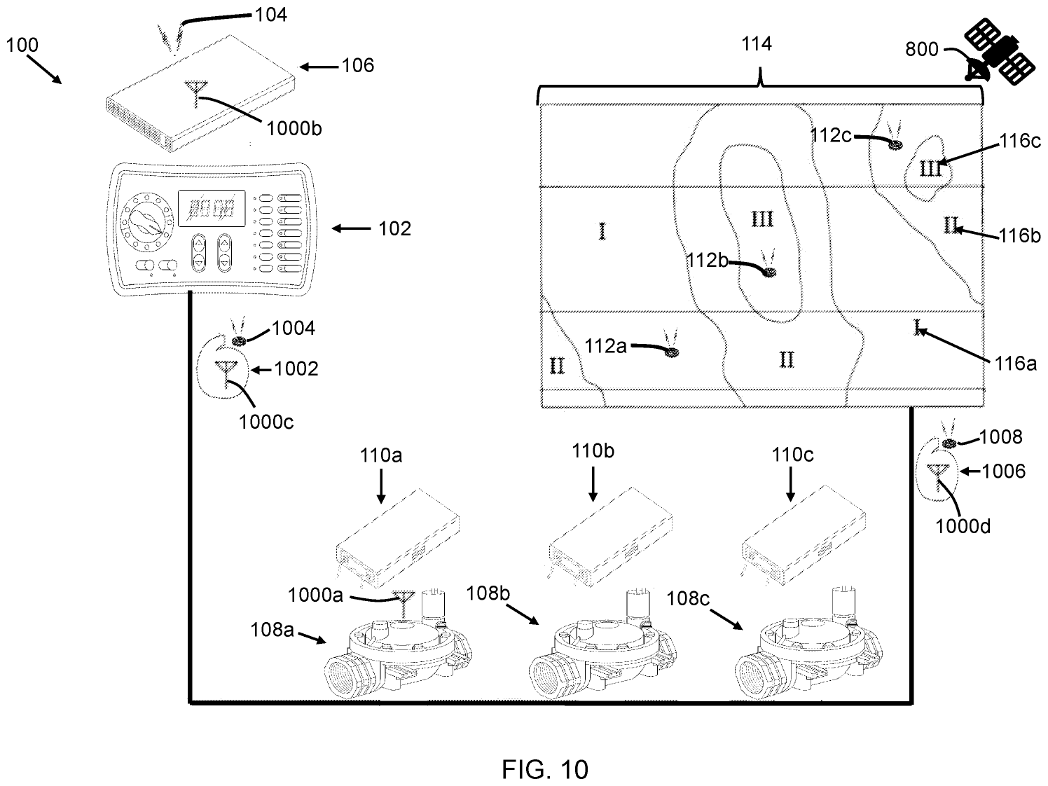

Looking now at FIG. 9, the assembly 100 may also include a GPS controller 900 positioned at or on the end of field 114 for controlling selected location and tracking functions of the assembly 100 independently from the hub controller 106. In one embodiment, the GPS controller 900 is operatively connected to a first and second GPS module 1000a, 1000b (See FIG. 10). The GPS controller 900 can be implemented with hardware, software, firmware, or a combination thereof, but may include the components illustrated in FIG. 9.

One possible embodiment of the GPS controller 900 comprises a location determining component 902, such as a GPS module and/or GPS receiver. The GPS controller 900 may also include a processing unit 904, one or more relays 906, 908, a plurality of inputs 910, an input port 912, and an output port 914. Those skilled in the art will recognize this circuitry for a GPS and other tracking and positioning systems.

In one embodiment, the aforementioned components of GPS controller 900 are enclosed in or supported on a weatherproof housing which protects against the elements, such as moisture, vibration, and impact. In yet other embodiments, the GPS controller 900 may also include a display screen and a power source such as a battery pack or solar cell. In yet another embodiment, GPS controller 900 is hardwired to a power source associated with the hub controller 106 or even the switch 110a.

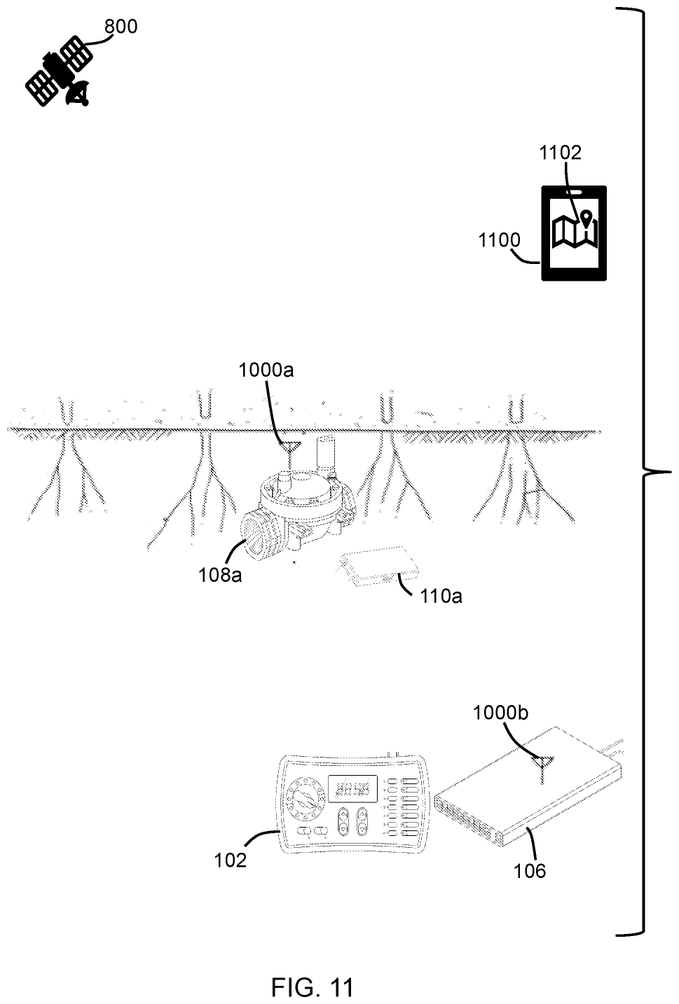

As referenced in FIG. 10, a first GPS module 1000a, or GPS receiver, is integrally connected to a solenoid valve 108a. The useful functionality for tracking, or locating a stationary solenoid valve is known in the art to be necessary, since solenoid valves used for irrigation are often buried beneath the ground. For example, FIG. 11 illustrates solenoid valve 108a and the accompanying switch 110a buried under the ground with the first GPS module 1000a attached thereto. In alternative embodiments, the first GPS module 1000a is connected to the switch that is hard wired to the solenoid valve, providing substantially the same locating capacity.

It is also instructive to note that the hub controller 106 is integrally connected and operational with a second GPS module 1000b, or GPS receiver. Similar to the first GPS module 1000a on the solenoid valve, the second GPS module 1000b receives satellite signals from a plurality of GPS satellites 806a-n in order to determine a current location of the hub controller 106 in relation to the solenoid valve 802 as a function of the received satellite signals 810 (See FIG. 10).

This secondary GPS module 1000b can be useful in large fields where many acres or miles separate the hub controller 106 from the solenoid valve 802. In alternative embodiments, the second GPS module 1000b is connected to the clock 102 that is hard wired to the hub controller 106, providing substantially the same locating capacity. The hub controller 106 and the connected clock 102 are in operational proximity to solenoid valve 108a, so as to enable transmitting the valve command signals 104 through the mesh network, as discussed above. In both cases, the solenoid valve and the hub controller 106 are locatable through use of GPS 800.

In operational use, a faulty solenoid valve 108a is identified through LED's in the hub controller that display specific colors to indicate an event, such as a faulty valve or maintenance being required for a valve or switch. A green LED illumination indicates the solenoid valve is fully operational. A yellow LED illumination indicates the solenoid valve is starting to show problems, or is nearing maintenance periods. A red LED illumination indicates the solenoid valve is faulty or nonoperational. Once a yellow or red LED illumination occurs, the location of the faulty solenoid valve may then be determined by the GPS 800.

Thus, after determining that the solenoid valve requires attendance, the first GPS module 1000a helps the technician track the exact location of the solenoid valve, which may be underneath the ground. In one embodiment, the technician has a communication device 1100 that displays a geo-map 1102 for visually indicating the location of the solenoid valve. Geo-map 1102 can include a digital map of the field, with icons depicting the location of landmarks and solenoid valves.

In another operational use, both the first and second GPS modules 1000a-b locate four or more satellites and calculate the distance to each satellite by timing a radio signal from each satellite to the receiver. In order to use this timing information the receiver, has to know the location of the satellites. Since the satellites travel in known orbit paths, the GPS receiver can receive and store the ephemeris and/or almanac that tells the receiver the location of the satellites at various times.

Thus, both the first and second GPS modules 1000a-b provide location information for their respective solenoid valve and hub controller by communicating with the satellites 806a, 806b, 806c, 806n that orbit the earth 804. Such GPS information may provide positioning accuracies that are superior to alternative technologies such as cellular cell-ID. And when combined with the mesh network, discussed above, the efficiency of transmitting valve control signals, and locating faulty solenoid valves creates an efficient irrigation operation.

Advantages that the UWB communication protocol provides in tracking the irrigation equipment include: Accuracy within the range of 10-30 cm; compared to 2-5 m for beacons and Wi-Fi. Another advantage of the UWB communication protocol includes: Real time data. The remote control device can monitor 1000+ UWB tags in real time, with real time analysis and reporting. Another advantage of the UWB communication protocol includes: No interference Exclusive 6.35 to 6.75 GHz frequency range. This restricts interference with other wireless communication devices, and allows for penetration through dense objects, such as hills, trees, or fences found in an irrigation field.

Yet another advantage of the UWB communication protocol includes: Fast update rates Position, with an update rate of up to 20 Hz. Another advantage of the UWB communication protocol includes: Long battery life, such low power consumption reduces maintenance hassle and cost. Another advantage of the UWB communication protocol includes: Security Data transfer via UWB is secure, because it can't be intercepted by a personal device.

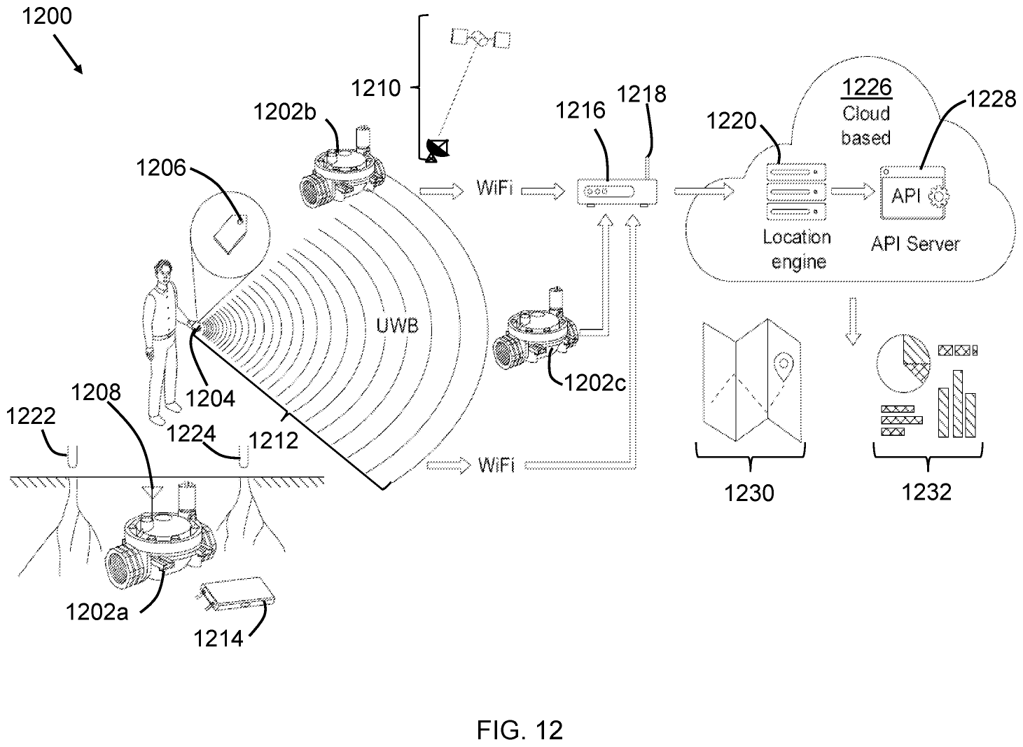

FIG. 12 illustrates a block diagram of a remote controlled system 1200 for precision tracking of irrigation equipment 1202a-c with GPS and ultra-wideband communication protocol. The remote controlled system 1200, hereafter “system 1200” is configured to track at least one irrigation equipment 1202a-c, including a solenoid valve. The system utilizes a global positioning system (GPS) for approximate tracking of the irrigation equipment 1202a-c; and an Ultra-Wideband (UWB) communication protocol for more precise location determination of the irrigation equipment 1202a-c.

The system 1200 also utilizes a remote control device 1204 to enable a user to be mobile while tracking the location of the irrigation equipment 1202a-c. The system 1200 remote control device 1204 is utilized to track the exact location of the irrigation equipment 1202a-c. As discussed above, the GPS tracks the approximate location of the solenoid valve, and the Ultra-Wideband communication protocol provides a more precise tracking capability, locating the exact location of solenoid valves and irrigation equipment 1202a-c, both underground, and above ground.

The remote control device 1204 and the agricultural clock, discussed above, are both in signal communication with the GPS and Ultra-Wideband communication protocols. Further, the agricultural clock utilizes a mesh network, i.e., Z-wave to transmit commands that control the timing and amount of water discharged through a solenoid valve across multiple agricultural zones. All of the components in the system 1200 may be in communication through the mesh network.

In regards to the GPS, a GPS module 1210 is utilized to provide location information for the solenoid valve and a hub controller by communicating with the satellites 806a, 806b, 806c, 806n that orbit the earth 804. Such GPS information may provide positioning accuracies that are superior to alternative technologies such as cellular cell-ID. And when combined with the mesh network, discussed above, the efficiency of transmitting valve control signals, and locating faulty solenoid valves creates an efficient irrigation operation. In some embodiments, GPS module 1210 is operable to receive satellite signals from the GPS satellites for determining an approximate location of the irrigation equipment 1202a-c as a function of the received satellite signals. Tower signals from multiple towers in proximity to the field may also be used to create a geo-fence approximate locator for the system 1200.

While GPS is effective for approximate location of an object, GPS and is not suitable or available for all tracking jobs. As one example, GPS systems is not currently available for fine tracking accuracy but where GPS does not operate well may cause undesired emissions or interference. Thus, UWB is utilized for more precise locating of the irrigation equipment 1202a-c, within the range of a few centimeters, in some embodiments.

It is known in the art that UWB communication protocols are a pulsed form of communications where the continuous carrier wave of traditional communications is replaced with a discrete pulse of electromagnetic energy. A ultra-wideband transmitter 1206 operates by sending billions of such pulses across the wide spectrum frequency. A corresponding UWB receiver 1208 then translates the pulses into data by listening for a familiar pulse sequence sent by the transmitter 1206.

One way to think of it is as a radar that can continuously scan an entire room and precisely lock onto an object like a laser beam to discover its location and communicate data. This is how the present invention discovers the location of the solenoid valves and other possible irrigation equipment 1202a-c. It is also significant to note that UWB pulses 1212 inherently displays a wide bandwidth (>500 MHz).

In some embodiments, the system 1200 comprises at least one irrigation equipment 1202a-c. The irrigation equipment 1202a-c may include a solenoid valve operable to regulate the flow of water, as discussed above. Solenoid valve 1202a may be underground, or solenoid valve 1202b, 1202c may be above ground. In both cases, system 1200 tracks location in a precise manner. However, in other embodiments, the irrigation equipment 1202a-c can be a flow sensor, a pump, and other irrigation-related equipment. The irrigation equipment 1202a-c can be tracked underground, as is known for solenoid valves, or above ground. However, any piece of equipment or livestock used in an irrigation or agricultural fields that would require tracking may also be tracked by the system 1200.

In other embodiments, the system 1200 comprises a GPS module 1210 that is integral in the irrigation equipment 1202a-c. The GPS module 1210 operable to receive satellite signals from a plurality of GPS satellites for determining an approximate location of the irrigation equipment 1202a-c as a function of the received satellite signals. The approximate location may be a distance of between 100 meters to 5,000 meters.

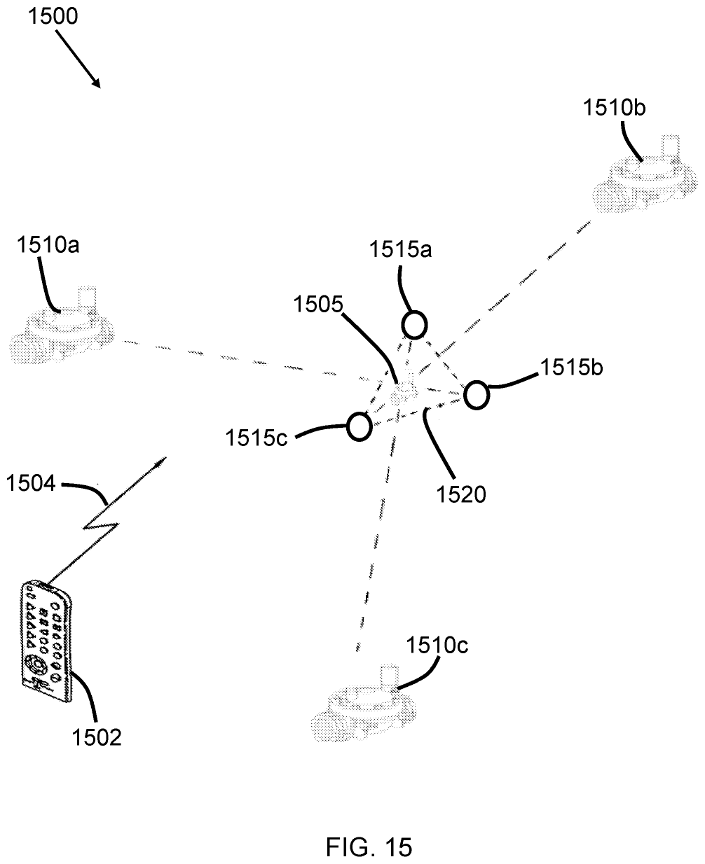

Looking again at FIG. 15, the system 1200 may include an ultra-wideband transmitter 1206. The ultra-wideband transmitter 1206 is configured to transmit a plurality of ultra-wideband pulses. UWB refers to a signal that has a −10 dB bandwidth greater than 500 MHz or a fractional bandwidth (bandwidth divided by the band center frequency) greater than 20%. In some embodiments, the plurality of ultrawideband pulses 1212 are used to help track a precise location of the irrigation equipment 1202a-c as a function of the ultra-wideband pulses 1212. In one possible embodiment, the precise location may be in the range of a few centimeters. In alternative embodiments, the ultra-wideband transmitter 1206 is a tag that transmits pings periodically.

In some embodiments, the system 1200 may also include an ultra-wideband receiver 1208 for location-related communication with the ultra-wideband transmitter 1206. The ultra-wideband transmitter 1206 and the ultra-wideband receiver 1208 range each other to determine precise location. To enable the transmission and reception of the ultra-wideband pulses 1212, the ultra-wideband transmitter 1206 comprises an ultra-wideband chip. Additionally, the ultra-wideband may also have an ultra-wideband chip.

The ultra-wideband receiver 1208 is also operatively connected to the irrigation equipment 1202a-c, including the solenoid valve, for regulation, operation, and tracking thereof. To enable processing of the ultra-wideband pulses 1212, the ultra-wideband receiver 1208 comprises one or more synchronized clock signals. The ultra-wideband receiver 1208 is configured to receive the ultra-wideband pulses, and convert the ultra-wideband pulses 1212 into data.

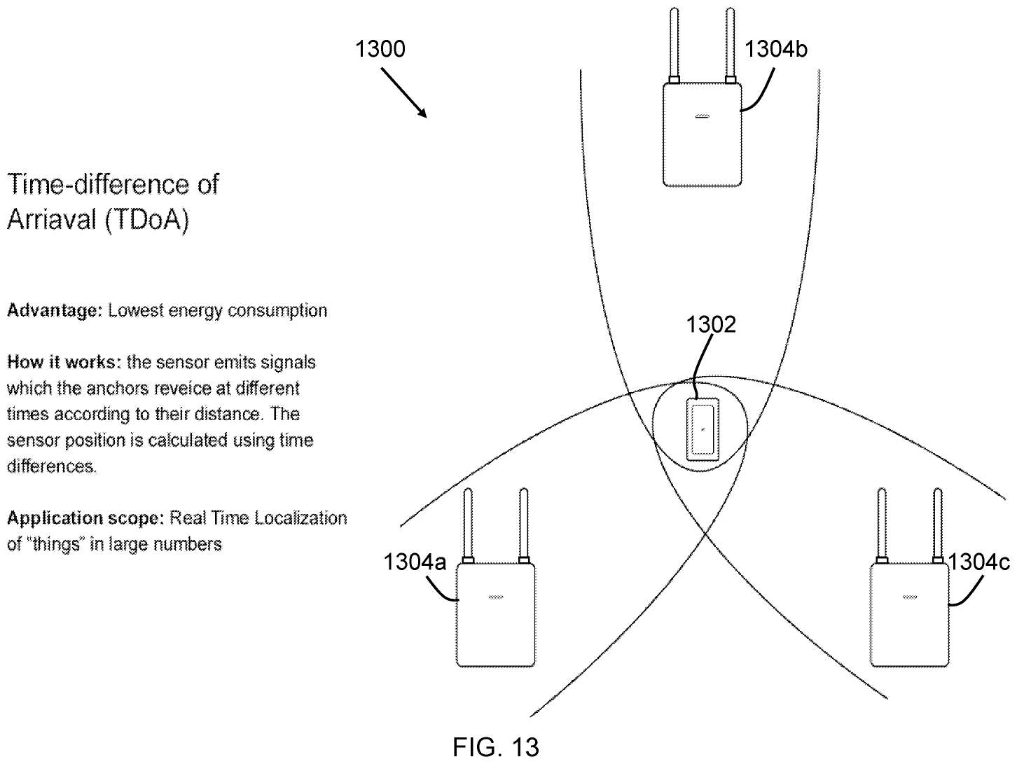

In this manner, the ultra-wideband transmitter 1206 and the ultra-wideband receiver 1208 are configured to range each other based on the amount of time that the ultra-wideband pulses 1212 travel between the ultra-wideband transmitter 1206 and the ultra-wideband receiver 1208. This allows for real time localizations of multiple irrigation equipment 1202a-c across a field. For example, FIG. 13 illustrates a block diagram of a Time-Distance of Arrival model 1300 between a sensor 1302 and three anchors 1304a, 1304b, 1304c. In the Time-Distance of Arrival (TDoA) configuration, the sensor 1302 emits ultra-wideband pulses 1212, which the anchors 1304a-c receive at different times according to their distance. And the position of the sensor is calculated using time differences.

In one localization embodiment, the sensor is operational as the ultra-wideband receiver 1208 connected to the irrigation equipment 1202a-c, and the anchors operate as would the ultra-wideband transmitter 1206. The model 1300 can also be applied to the ultra-wideband transmitter 1206 in real time localization with the ultra-wideband receiver 1208; or the ultra-wideband transmitter 1206 in real time localization with the antennas; or the ultra-wideband transmitter 1206 in real time localization with the clock; or the ultra-wideband transmitter 1206 in real time localization with the real time location server.

UWB leverages the TDoA to measure the distance between two radio transceivers by multiplying the Time of Flight of the ultra-wideband pulses 1212 by the speed of light. From this basic principle, UWB technology can be implemented in different ways based on the target applications needs: Two Way Ranging, Time Difference of Arrival (TDoA), or Phase Difference of Arrival (PDoA). In one possible embodiment, multiple reference points, called anchors, are deployed in a venue and are time synchronized.

Next, the remote control device 1204, or the smart phone, will beacon, and when an anchor receives the beacon signal it will timestamp it. The timestamp from multiple anchors is then sent back to a central location engine which will run multilateration algorithms based on TDoA of the beacon signals to compute the X, Y, Z of the remote control device 1204. However, the ultra-wideband transmitter 1206 operates substantially the same as the anchors.

In alternative embodiments, the ultra-wideband receiver 1208 is configured to receive the plurality of ultra-wideband pulses 1212 and produce ultra-wideband pulse waveforms data, wherein the ultrawideband receiver 1208 is operably connected to the antennas. The at least one ultrawideband receiver 1208 is asynchronous with respect to the ultra-wideband transmitter 1206. The ultra-wideband receiver 1208 is programmed to divide a scan of the ultrawideband pulse waveform data into a plurality of segments.

In alternative embodiments, the ultra-wideband receiver 1208 transmits a plurality of pings. In this ping-generation configuration, a real time location server is used, and configured to read the plurality of pings transmitted by the ultrawideband receiver 1208. The real time location server calculates the relative position of the ultra-wideband transmitter 1206 and the ultra-wideband receiver 1208 based on the pings. This serves as a time of flight-type operation to precisely locate the irrigation equipment 1202a-c.

Continuing with the system 1200, a clock 1216 may be used to communicate with the ultra-wideband transmitter 1206 and the ultra-wideband receiver 1208 over the mesh network. Thus, the clock 1216 has a transreceiver 1218 that receives and/or transmits the UWB pulses 1212. However, in alternative embodiments, the communication may be over other types of networks. The clock 1216 is configured to generate one or more command signals, the command signals operable to control the irrigation equipment 1202a-c. Additionally, the system 1200 utilizes a hub controller 1220 that is operatively connected to the clock 1216, as discussed above. The hub controller 1220 is configured to transmit the command signals over a mesh network. To help carry the command signal over the mesh network, multiple signal repeaters 1222 are utilized.

Additionally, a switch 1214 is operatively connected to the irrigation equipment 1202a-c. The switch 1214 is configured to receive the command signals. The switch is configured to control the irrigation equipment 1202a-c in correspondence to the command signals. In some embodiments, the mesh network may include, without limitation, a Z-wave network, a Zigbee network, a packet radio network, a thread network, a Smash network, a SolarMESH project network, and a WiBACK wireless technology network.

In some embodiments, the system 1200 can include one or more antennas that are operatively connected to the irrigation equipment 1202a-c. The antennas operable to receive the ultrawideband pulses for enhancing the range and reception reliability of the ultra-wideband transmitter 1206. One possible embodiment, the antennas are operatively connected to the ultra-wideband transmitter 1206. In one non-limiting embodiment, the antennas comprise a multiple-input and multiple-output distributed antenna.

Continuing with the system 1200, one or more ultra-wideband anchors 1224, known in the art of ultra-wideband communication protocols, may be used. The ultra-wideband anchors 1224 are operatively connected to the ultra-wideband transmitter 1206 and the ultra-wideband receiver 1208. This may be a wireless or a wire connection. In some embodiments, the ultra-wideband anchors 1224 are operable to receive the ultra-wideband pulses 1212 and calculate the relative position of the ultra-wideband transmitter 1206 and the ultra-wideband receiver 1208.

In alternative embodiments of the system 1200, at least one computer is operably connected with each of the ultra-wideband receiver and capable of receiving the ultrawideband pulse waveform data from the ultrawideband receiver. The computer is programmed to separately and near simultaneously receive multiple streams of the plurality of segments of the ultrawideband pulse waveform data from multiple ultrawideband receivers associated with the plurality of clusters until all of said plurality of segments has been received.

Further, the computer may be programmed to utilize the ultra-wideband pulse waveform data to produce time difference of arrival information for the two antennas for each of the plurality of clusters. The computer is also programmed to determine an angle of arrival information from the time difference of arrival information. The computer is also programmed to utilize said angle of arrival information for tracking said ultrawideband transmitter.

Turning now to a comparison analysis between the GPS and the UWB, it is known in the art that UWB waveforms have been used to achieve extremely fine, centimeter-type resolutions because of their extremely short (subnanosecond to nanosecond) durations. It is also known that GPS uses the Global Positioning System (GPS) to determine its movement and determine its WGS84 U™ geographic position (geotracking) to determine its location. In any case, as used in the present invention, the system 1200 utilizes GPS to track the general area of the solenoid valve, and UWB to locate the precise location of the solenoid valve underground, or in some case, above ground. These two tracking means are compared below.

Continuing with FIG. 12, the system 1200 operates with a cloud 1226. The cloud 1226 supports an API server 1228 that enables a user to develop a web application to view a location 1230 of the irrigation equipment 1202a-c, and develop statistical analysis 1232 of the location for the irrigation equipment 1202a-c. Such a web application can be viewable on a smart phone, tablet, or central computing site for optimizing the irrigation process.

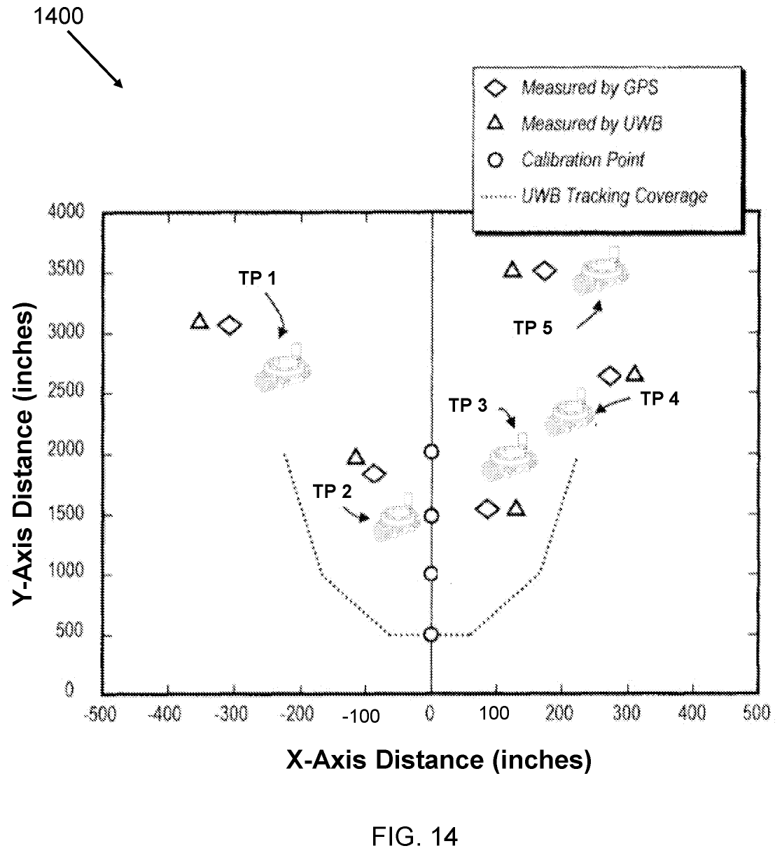

As referenced in FIG. 14, a graph 1400 shows tracking measurements of a prototype UWB passive tracking system as compared to tracking measurements utilizing a GPS system. Results of tests of tracking accuracy of a prototype of UWB tracking system, within inches, are shown in FIG. 14. For purposes of tracking in an irrigation environment, the short distance tracking is important when looking for multiple solenoid valves underground. Thus, the estimated UWB tracking coverage is indicated by the dashed lines in FIG. 14.

In regards to the calibration points illustrated in FIG. 14, shown in circles, in order to determine the effective length of an associated cable for each antenna, calibration points were utilized. The use of cables will be discussed in more detail, infra. The effective cable length takes into account temperature and other environmental changes that affect the propagation time through a cable.

FIG. 15 is a schematic diagram of a UWB geo-positional model 1500 where multiple remote controllers or mobile devices collaborate with a requesting tag to allow the requesting tag to determine its location and elevation. The model 1500 references multiple ultra-wideband (UWB) devices collaborate with a requesting tag on a solenoid valve to enable the requesting tag to determine its location and elevation in the irrigation field. This enables the elevation of the UWB requesting solenoid valve 1505 to be determined. This can be helpful in many situations, for example, where the location of an individual in a high-rise building must be determined. In addition, one feature of this embodiment of the present invention is that it accounts for situations where the elevation between the UWB requesting solenoid valve 1505 is not the same as the elevation of the other UWB requesting solenoid valves 1510a, 1510b, 1510c.

Referring again to FIG. 15, the diagram 1500 illustrates a remote control 1502 used to determine the location of a UWB requesting solenoid valve 1505 by measuring the time delay in a signal 1504 transmitted by the UWB requesting solenoid valve 1505 to the remote control 1502 and other UWB solenoid valves 1510a-c. The UWB solenoid valves 1510a-c may have either a fixed location or they may be mobile UWB units. One method of finding the location of the UWB requesting solenoid valve 1505 employs radio triangulation and calculates distance from the amount of time required for a signal transmitted by the UWB requesting solenoid valve 1505 to reach each of the UWB solenoid valves 1510a-c.

Specifically, the distance between the UWB requesting solenoid valve 1505 and each of the UWB solenoid valves 1510a-c can be determined based on the amount of time it takes for a signal to travel between the devices. Each distance generates a radius, with each UWB unit 1510 at the center of a circle defined by each radius. The intersection of the three circles defines the location of the UWB requesting solenoid valve 1505. Tertiary devices, fixed or mobile, may submit information to the UWB solenoid valves 1510a-c which will then relay the information to the UWB requesting solenoid valve 1505, or the tertiary devices may submit the information directly to the UWB requesting solenoid valve 1505.

Looking again at FIG. 15, a method of determining an elevation of an UWB requesting solenoid valve 1505 will now be described. As shown in the Figure, a calculated distance from each UWB unit 1510 may result in three different elevation error points 1515a, 1515b, 1515c. This may occur when an UWB requesting solenoid valve 1505 transmits a request to the UWB solenoid valves 1510a-c to determine a location of the UWB requesting solenoid valve 1505, and the UWB requesting solenoid valve 1505 is at a different elevation than the UWB solenoid valves 1510a-c. The elevation error points 1515a-c represent distances that are beyond the actual location of the UWB requesting solenoid valve 1505. The additional distance reflects the elevation difference between the UWB requesting solenoid valve 1505 and the UWB solenoid valves 1510a-c.

In alternative embodiments, computer logic or computer readable program code is used to determine a position and elevation of an UWB requesting solenoid valve 1505 when the elevation of the UWB requesting solenoid valve 1505 is different than the elevation of the UWB solenoid valves 1510a-c. One method involves the use of the Pythagorean theorem. This method employs the total distance from a UWB unit 1500 to the elevation error point 1515a-c as the hypotenuse of a triangle. Another side of the triangle is determined by taking the difference between the distance from the UWB requesting solenoid valve 1505 and the elevation error point 1515a-c and subtracting that distance from the distance between the UWB unit 1500 and the elevation error point 1515a-c. With two sides of an imaginary triangle determined, the third side of the triangle can be found using the Pythagorean theorem. In the present invention, the third side of the triangle represents the elevation of the UWB requesting solenoid valve 1505.

The above-described calculations require an approximate location of the UWB requesting solenoid valve 1505. One embodiment of the present invention determines a centroid of the elevation error area 1520. The centroid of the elevation error area 1520 is then used as an approximate location of the UWB requesting solenoid valve 1505. The elevation error area 1520 comprises an area defined by three imaginary lines joining the three elevation error points 1515a-c, and the centroid is the point within the area at which the center of mass would be if the area had a mass.

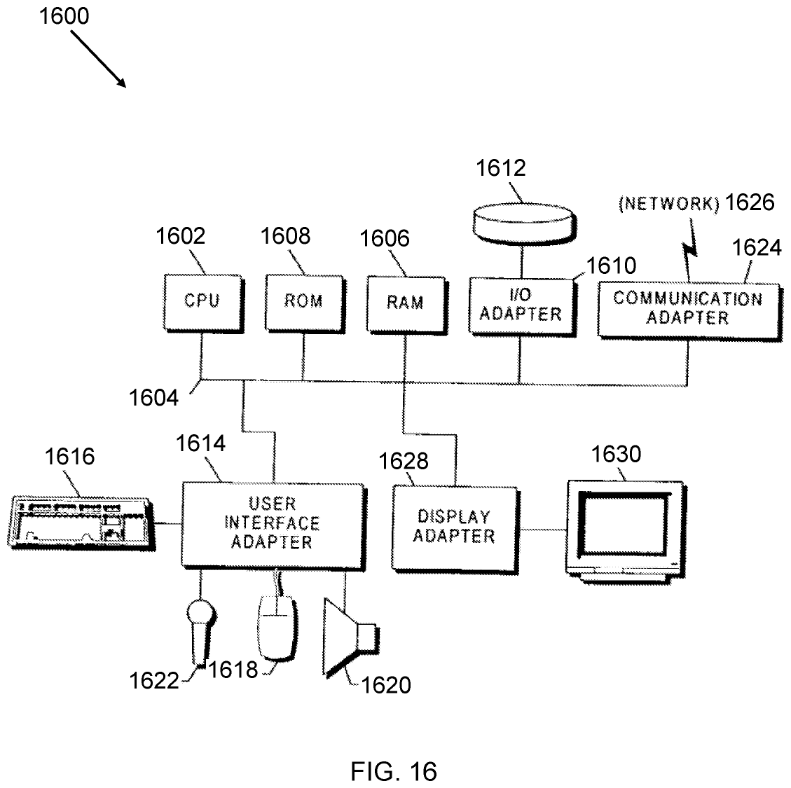

FIG. 16 illustrates a schematic diagram of exemplary hardware environment for operation of the ultra-wideband system.

FIG. 16 illustrates a representative hardware environment 1600 by which embodiments of the present invention may be carried out is depicted in FIG. 16. In the present description, the various sub-components of each of the components may also be considered components of the system. For example, particular software modules executed on any component of the system may also be considered components of the system. The hardware configuration 1600 illustrated in FIG. 16 includes a central processing unit 1602, such as a microprocessor, and a number of other units interconnected via a system bus 1604.

The hardware configuration 1600 shown in FIG. 16 includes a Random Access Memory (RAM) 1606, Read Only Memory (ROM) 1608, an adapter 1610 for connecting peripheral devices such as disk storage units 1612 to the bus 1604, a user interface adapter 1614 for connecting a keyboard 1616, a mouse 1618, a speaker 1620, a microphone 1622, and/or other user interface devices such as a touch screen (not shown) to the bus 1604, communication adapter 1624 for connecting the hardware configuration to a communication network 1626 (e.g., a data processing network) and a display adapter 1628 for connecting the bus 1604 to a display device 1630.

In alternative embodiments, a Long Range (LoRa) network is utilized in the system for controlling irrigation equipment, including the solenoid valve. Significantly, the LoRa network enables long-range transmissions with low power consumption. This can be effective for larger irrigation fields in which hills, fences, and livestock can block signals. With such a proprietary low-power wide-area network modulation technique, the system can operate on either a mesh network or the LoRa network for communicating between the clock, the remote control device, and the irrigation equipment.

In some embodiments, the LoRa network can be controlled via the Internet with intercommunication between multiple relay points positioned throughout agricultural zones. In other embodiments, the LoRa network may also include an Internet Wi-Fi transceiver. The Z-wave network 250 may also include multiple signal repeaters 112a-c that are operatively disposed across the zones. In other embodiments, the signal repeaters 112a-c are operatively disposed between tables and across walls in the zones.

Those skilled in the art will recognize that a LoRa WAN implements a star network topology in which end nodes transmit data to a central server via one or multiple gateways. All devices in a LoRa WAN network are asynchronous and transmit data only when data is available. To increase the security and range of the LoRa WAN network, it is possible to be deployed as a mesh network.

In conclusion, the remote controlled system 1200 for precision tracking of irrigation equipment with GPS and ultra-wideband communication protocol is designed to track irrigation equipment, including a solenoid valve, through use of a GPS, and a UWB communication protocol with a remote control device. The system provides a remote control device to track the location of the solenoid valve, or other irrigation equipment. The GPS tracks the approximate location of the solenoid valve, and the UWB communication protocol provides a more precise tracking capability, locating the exact location of solenoid valves, both underground, and above ground. The remote control device and an agricultural clock, are both in signal communication with the GPS and Ultra-Wideband communication protocols. Further, the agricultural clock utilizes a mesh network, i.e., Z-wave to transmit commands that control the timing and amount of water discharged through the solenoid valve across multiple agricultural zones.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A remote controlled system for precision tracking of irrigation equipment with a global positioning system and an ultra-wideband communication protocol, the system comprising:
at least one irrigation equipment;
a GPS module integral in the irrigation equipment, the GPS module operable to receive satellite signals from a plurality of GPS satellites for determining a location of the irrigation equipment as a function of the received satellite signals;
an ultra-wideband transmitter operable to transmit a plurality of ultra-wideband pulses, the plurality of ultra-wideband pulses operable to help track the location of the irrigation equipment as a function of the ultra-wideband pulses;
an ultra-wideband receiver operatively connected to the irrigation equipment, the ultra-wideband receiver comprising one or more synchronized clock signals, the ultra-wideband receiver operable to receive the ultra-wideband pulses, and convert the ultra-wideband pulses into data,
whereby the ultra-wideband transmitter and the ultra-wideband receiver are configured to range each other based on the amount of time that the ultra-wideband pulses travel between the ultra-wideband transmitter and the ultra-wideband receiver;
a clock being operable to communicate with the ultra-wideband transmitter, or the ultra-wideband receiver, or both,
the clock further being operable to generate one or more command signals, the command signals operable to control the irrigation equipment;
a hub controller operatively connected to the clock, the hub controller operable to transmit the command signals over a mesh network;
multiple signal repeaters operable to carry the command signals across the mesh network; and
a switch operatively connected to the irrigation equipment, the switch operable to receive the command signals, the switch operable to control the irrigation equipment in correspondence to the command signals.

2. The system of claim 1, further comprising one or more antennas operatively connected to the irrigation equipment, the antennas operable to receive the ultra-wideband pulses for enhancing the range and reception reliability of the ultra-wideband transmitter.

3. The system of claim 2, wherein the antennas are operatively connected to the ultra-wideband transmitter.

4. The system of claim 2, wherein the antennas comprise a multiple-input and multiple-output distributed antenna.

5. The system of claim 2, wherein the ultra-wideband receiver operable to receive the receiving the plurality of ultrawideband pulses and produce ultra-wideband pulse waveforms data, wherein the ultra-wideband receiver is operably connected to the antennas, wherein said at least one ultra-wideband receiver is asynchronous with respect to the ultra-wideband transmitter, and wherein the ultra-wideband receiver is programmed to divide a scan of the ultrawideband pulse waveform data into a plurality of segments.

6. The system of claim 2, further comprising one or more ultra-wideband anchors, the ultra-wideband anchors being operatively connected to the ultra-wideband transmitter and the ultra-wideband receiver.

7. The system of claim 6, wherein the ultra-wideband anchors are operable to receive the ultrawideband pulses and calculate the relative position of the ultra-wideband transmitter and the ultra-wideband receiver.

8. The system of claim 1, wherein the ultra-wideband receiver transmits a plurality of pings.

9. The system of claim 8, further comprising a real time location server operable to read the plurality of pings transmitted by the ultra-wideband receiver.

10. The system of claim 9, wherein the real time location server calculates the relative position of the ultra-wideband transmitter and the ultra-wideband receiver based on the pings.

11. The system of claim 2, wherein the clock is operable to communicate with the ultra-wideband transmitter and the ultra-wideband receiver over the mesh network, wherein the clock comprises a transreceiver for receiving and transmitting the ultra-wideband pulses.

12. The system of claim 2, wherein the mesh network includes at least one following networks: a Z-wave network, a Zigbee network, a packet radio network, a thread network, an Smash network, a SolarMESH project network, and a WiBACK wireless technology network.

13. The system of claim 1, wherein the GPS module is operable to receive satellite signals from the GPS satellites for determining an approximate location of the irrigation equipment as a function of the received satellite signals.

14. The system of claim 13, wherein the ultra-wideband transmitter is operable to transmit a plurality of ultra-wideband pulses, the plurality of ultra-wideband pulses operable to help track a precise location of the irrigation equipment as a function of the ultra-wideband pulses.

15. The system of claim 1, wherein the ultra-wideband transmitter comprises an ultra-wideband chip.

16. The system of claim 1, wherein the ultra-wideband pulses operable to help track the location of the irrigation equipment in the range of a few centimeters.

17. The system of claim 1, wherein the ultra-wideband transmitter comprises a remote control device or a smart phone.

18. The system of claim 1, wherein the irrigation equipment comprises a solenoid valve operable to regulate the flow of water.

19. A remote controlled system for precision tracking of irrigation equipment with a global positioning system and an ultra-wideband communication protocol, the system comprising:
at least one irrigation equipment;
a GPS module integral in the irrigation equipment, the GPS module operable to receive satellite signals from a plurality of GPS satellites for determining a location of the irrigation equipment as a function of the received satellite signals,
the GPS module further being operable to receive cell tower signals from a plurality of cell towers for determining a location of the irrigation equipment as a function of the received cell tower signals;
an ultra-wideband transmitter operable to transmit a plurality of ultra-wideband pulses across the wide spectrum frequency, the plurality of ultrawideband pulses operable to help track the location of the irrigation equipment as a function of the ultra-wideband pulses;
an ultra-wideband receiver operatively connected to the irrigation equipment, the ultra-wideband receiver comprising one or more synchronized clock signals, the ultra-wideband receiver operable to receive the ultra-wideband pulses, and convert the ultra-wideband pulses into data,
whereby the ultra-wideband transmitter and the ultra-wideband receiver are configured to range each other based on the amount of time that the ultra-wideband pulses travel between the ultra-wideband transmitter and the ultra-wideband receiver;
a clock being operable to communicate with the ultra-wideband transmitter, or the ultra-wideband receiver, or both,
the clock having a transreceiver for receiving and transmitting the ultra-wideband pulses,
the clock further being operable to generate one or more command signals, the command signals operable to control the irrigation equipment;
a hub controller operatively connected to the clock, the hub controller operable to transmit the command signals over a mesh network;
multiple signal repeaters operable to carry the command signals across the mesh network;
a switch operatively connected to the irrigation equipment, the switch operable to receive the command signals, the switch operable to control the irrigation equipment in correspondence to the command signals;
one or more antennas operatively connected to the irrigation equipment, the antennas operable to receive the ultrawideband pulses for enhancing the range and reception reliability of the ultra-wideband transmitter; and
one or more ultra-wideband anchors, the ultra-wideband anchors being operatively connected to the ultra-wideband transmitter, or the ultra-wideband receiver, or both.

20. A remote controlled system for precision tracking of irrigation equipment with a global positioning system and an ultra-wideband communication protocol, the system consisting of:
at least one solenoid valve;
a GPS module integral in the solenoid valve, the GPS module operable to receive satellite signals from a plurality of GPS satellites for determining a location of the solenoid valve as a function of the received satellite signals,
the GPS module further being operable to receive cell tower signals from a plurality of cell towers for determining a location of the solenoid valve as a function of the received cell tower signals;
a remote control device operable to transmit a plurality of ultra-wideband pulses across the wide spectrum frequency, the plurality of ultrawideband pulses operable to help track the location of the solenoid valve as a function of the ultra-wideband pulses;
an ultra-wideband receiver operatively connected to the solenoid valve, the ultra-wideband receiver comprising one or more synchronized clock signals, the ultra-wideband receiver operable to receive the ultra-wideband pulses, and convert the ultra-wideband pulses into data,
whereby the remote control device and the ultra-wideband receiver are configured to range each other based on the amount of time that the ultra-wideband pulses travel between the remote control device and the ultra-wideband receiver;
a clock being operable to communicate with the remote control device, or the ultra-wideband receiver, or both,
the clock comprising a transreceiver for receiving and transmitting the ultra-wideband pulses,
the clock further being operable to generate one or more command signals, the command signals operable to control the solenoid valve;
a hub controller operatively connected to the clock, the hub controller operable to transmit the command signals over a Z-wave network;
multiple signal repeaters operable to carry the command signals across the Z-wave network;
a switch operatively connected to the solenoid valve, the switch operable to receive the command signals, the switch operable to control the solenoid valve in correspondence to the command signals;
one or more antennas operatively connected to the solenoid valve, the antennas operable to receive the ultrawideband pulses for enhancing the range and reception reliability of the remote control device;
one or more ultra-wideband anchors, the ultra-wideband anchors being operatively connected to the remote control device and the ultra-wideband receiver;
a real time location server operable to communicate with the ultra-wideband receiver;
whereby the signal repeaters are operatively disposed across multiple agricultural zones for transmitting the command signals through the Z-wave network, and across the agricultural zones; and
whereby the hub controller, or the switch, or both comprise an Internet Wi-Fi transceiver, a transreceiver, and multiple channels, the channels corresponding to the agricultural zones, the channels operable to enable and restrict communications between the hub controller and the switches in corresponding agricultural zones.
